(19) United States
(12) Patent Application Publication
(10) Pub. No.: US 2017/0052159 A1
(43) Pub. Date: Feb. 23, 2017

(54) METHOD FOR ESTIMATING A QUANTITY OF PARTICLES DIVIDED INTO CLASSES, USING A CHROMATOGRAM

(71) Applicant: Commissariat A L'Energie Atomique et aux Energies Alternatives, Paris (FR)

(72) Inventors: Olivier HARANT, Saint-Egreve (FR); Francois BERTHOLON, La Tronche (FR); Pierre GRANGEAT, Saint-Ismier (FR)

(73) Assignee: Commissariat A L'Energie Atomique et aux Energies Alternatives, Paris (FR)

(21) Appl. No.: 15/241,197

(22) Filed: Aug. 19, 2016

(30) Foreign Application Priority Data
Aug. 20, 2015 (FR) 15 57847

(51) Int. Cl. G01N 30/86; G01N 15/06

(52) U.S. Cl. CPC G01N 30/8693; G01N 15/06

(57) ABSTRACT

The invention is a method for estimating a quantity or a concentration of particles using a detector disposed at the exit of a chromatography column. The estimation is carried out on the basis of a selection of a plurality of retention times within the histogram, each retention time being associated with an individual particle. The method aims to classify each retention time into one or more classes, each class being representative of a species of particles. The method can include an estimation of the number of classes.

### TECHNICAL FIELD

The technical field of the invention is that of chromatography in a liquid or gaseous phase. It relates more particularly to a method allowing the interpretation of a chromatogram.

### PRIOR ART

The use of chromatography is a very widespread technique for the analysis of chemical species in a liquid or gaseous medium. This analysis technique is based on chromatography columns, whose operation is well known: a particle travels along a channel, between an entry and an exit, while being carried by a fluid, known as carrier fluid, also denoted by the term mobile phase. The wall of the channel comprises a coating, called stationary phase, with which the particle exhibits an affinity, in such a manner that the particle is able to be adsorbed, then desorbed. Depending on the affinity with the stationary phase, the travel time of the particle through the channel may be longer or shorter. A chromatography column also comprises a detector, usually placed at the exit of the channel, in order to detect the particle when the latter exits the channel.

Generally speaking, the signal detected by the detector takes the form of a histogram representing the number of detections as a function of time, this histogram being denoted by the term chromatogram.

When a sample, containing particles of various species, is injected at the same time into a column, the travel time of each particle depends on its affinity with the stationary phase, the latter depending on the chemical species of the particle. Accordingly, the chromatogram exhibits various peaks, each peak representing the travel time of particles of the same species within the column.

Based on a chromatogram, inversion algorithms allow the quantities of particles of each species, in the sample, to be estimated from each peak. The U.S. Pat. No. 7,949,476 describes for example an inversion algorithm using Bayesian inference, based on an analytical model of a chromatography column. Each peak is considered as a probability density, whose random variable is the retention time of each particle associated with this peak. A chromatogram is then considered as a sum of pulse responses, weighted by the concentration of each type of particle composing the various peaks. In other words, the chromatogram S can be modelled by S(t)=Σₖ₌₁^{M} Cₖp(t, θₖ), where M is the number of species of particles in the sample, Cₖ is the concentration of particles of each species k, t represents time and θₖ is a vector of the parameters of the probability density modelling the peak k.

The European Patent EP2509018 describes an analogous method, introducing a probabilistic dependence of the parameters modelling the chromatogram, defining a hierarchical probabilistic model

The inventors have provided an alternative to these inversion methods, allowing the concentration of all the components of a mixture to be estimated, with no prior assumption on their numbers, nor on the shape of the peaks of the chromatogram.

### DESCRIPTION OF THE INVENTION

One subject of the invention is a method for estimating a quantity of particles present in a sample according to one of the appended claims.

Another subject of the invention is also a medium, readable by a processor, comprising instructions for the execution of a method as described below. Another further subject of the invention is chromatography column for analysing a liquid or gaseous sample, comprising a detector, disposed at the exit of the column, and a processor designed to process the signal generated by the detector. The processor is configured to run instructions for implementing the method described herein.

### FIGURES

FIG. 1 shows a device allowing the implementation of the invention.

FIG. 2 shows a chromatogram. The abscissa axis corresponds to the retention time; the ordinate axis corresponds to the amplitude of the signal from a detector disposed at the exit from the column, representing the number of molecules detected at each retention time.

FIG. 3 shows the hierarchical statistical model of the embodiment described.

FIG. 4A shows the main steps of a method according to one embodiment according to the invention. FIGS. 4B and 4C respectively show sub-steps of this method.

FIG. 5A shows one example of a chromatogram generated using a test sample.

FIG. 5B shows the results of the classification of the molecules present in the test sample, using the chromatogram shown in FIG. 5A, as the algorithm is iterated.

### DESCRIPTION OF PARTICULAR EMBODIMENTS

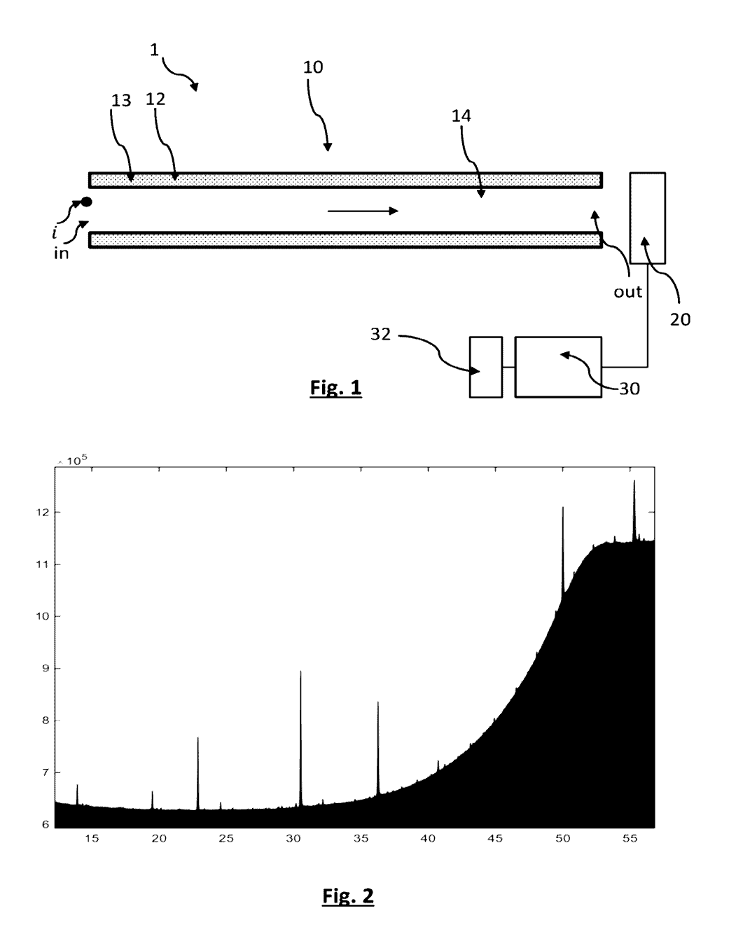

FIG. 1 shows a chromatography column 1, comprising a channel 10 and a detector 20. The wall of the channel 10 comprises a coating 12, referred to as stationary phase 13. The channel also comprises a central part 14 in which a carrier fluid is able to flow between an entry ‘in’ and an exit ‘out’.

The carrier fluid may be a gas or a liquid, whose affinity with the stationary phase 13 is negligible, such that the carrier fluid does not interact with the stationary phase during its passage within the column. Its travel time in the column, in other words between the entry and the exit of the column, is denoted by the term ‘dead time’, and denoted t₀. This dead time t₀ corresponds to the travel time of a particle not interacting with the stationary phase.

An analysis consists in introducing a sample to be analysed comprising a mixture of particles of various species, each molecule i of species k having a concentration Cₖ in the sample. The sample to be analysed may be liquid or gaseous. A detector 20 is placed at the exit of the channel, designed to emit a signal representative of the number of particles exiting from the column as a function of time. This signal corresponds to the chromatogram mentioned in the description of the prior art. The chromatography then aims to identify the various species constituting the sample and to determine their quantities, proportions or concentrations.

The term ‘particle’ is understood to mean a molecule, a protein or a peptide, a complex of molecules, an aggregate of molecules, a nanoparticle. In the following part of the description, each particle is a molecule.

The phrase ‘species of a particle’ is understood to mean the chemical or biological species of the said particle.

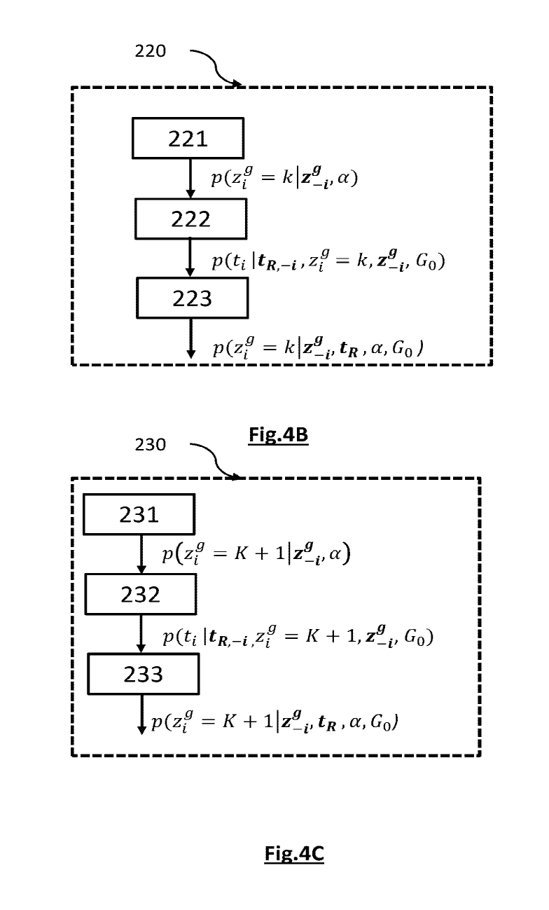

The detector 20 is designed to be connected to a processor 30, the latter being connected to a memory 32 comprising instructions, the latter being executable by the processor 30 in order to implement the method shown in FIGS. 4A, 4B and 4C, and described hereinafter. These instructions can be saved on a recording medium, readable by a processor, of the hard disk, CDROM or other type of memory.

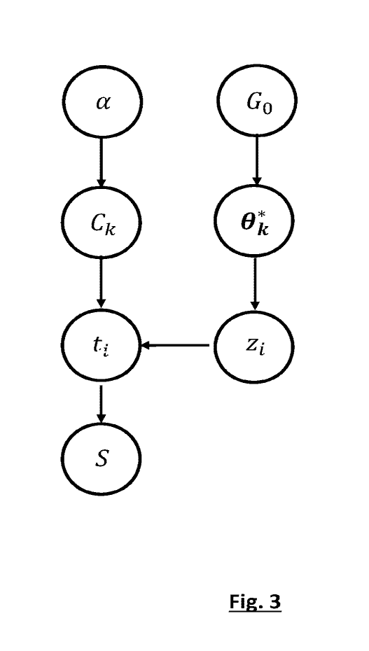

FIG. 2 shows one example of a chromatogram S generated by the detector 20. The chromatogram takes the form of a histogram of the retention times, each channel t of the histogram representing one interval of retention time [t, t+δt]. The chromatogram corresponds to a discrete distribution of the retention times of the mixture. The aim of the invention is to obtain, based on this chromatogram, a classification of the retention times into various classes, each class being considered as representative of a species of molecule, then to estimate a quantity (or a proportion) of molecules belonging to each class.

In contrast to the methods of the prior art, the estimation of a quantity of molecules based on each peak is not carried out by Bayesian inference based on an analytical model of the pulse response. One notable aspect of the invention is the constitution of a list of N retention times tᵢ of individual molecules i, by random selection according to the chromatogram S, based on which a classification is made of each retention time, taken individually, according to a class k, with no prior assumptions on the number of classes. The classification is carried out by Bayesian inference, notably a non-parametric Bayesian inference, by considering that each retention time tᵢ for a molecule i belongs to a class k from amongst K classes, with 1≦k≦K, and that the retention times tᵢ of the same class k are distributed according to a probability distribution of the retention times p(t; θ*ₖ), with parameters θ*ₖ. The number of classes K may or may not be known a priori.

Each retention time tᵢ within the list corresponds to the retention time of an individual molecule i. In other words, the establishment of the list corresponds to a survey of a population of retention times constituting the chromatogram. The number N of retention times constituting the list is predetermined and is preferably sufficiently high for the population of the retention times on the list to be representative of the sample. Usually, N≧100 or N≧1000. The classification of each retention time tᵢ amounts to classifying the molecule i with which it is associated.

Each retention time tᵢ on the list is distributed according to a mixture of K probability distributions p(tᵢ; θ*ₖ), in such a manner that tᵢ˜Σₖ₌₁^{K} Cₖp(tᵢ; θ*ₖ), Cₖ being a quantity or a proportion of molecules within a class k. This may notably be a proportion of molecules within a class with respect to all of the molecules constituting the list. The symbol ˜ signifies “is distributed according to”.

Certain probability distributions p(t; θ*ₖ) may correspond to noise. Accordingly, the classification can establish one or more classes representative of noise.

The aim of the inversion is to determine, using the list of N retention times tᵢ, 1≦i≦N, the class k to which each retention time composing the list belongs. The variable zᵢ is the class of which each retention time tᵢ is a member. As previously described, the number of classes K may not be defined a priori, and is then determined during the process of classification.

According to one embodiment, the inversion is carried out according to a non-parametric Bayesian model, the mixture of the retention times on the list being modelled by a Dirichlet Process Mixture Model, known by the acronym DPMM. It is assumed that all the classes are characterized by the same parametric family of laws. The parameters associated with each class k form a vector θ*ₖ. The vectors θ*ₖ follow a distribution G₀, called base distribution. The base distribution G₀ is to be considered as a hyper-parameter, in other words a fixed parameter.

The DPMM are also parameterized by a scale factor α. This scale factor is a positive scalar. It conditions the number of classes taken into account during the inference. Indeed, if N represents the number of data values to be classified, in this case the number of retention times tᵢ forming the list, and K represents the number of classes,

$$E ( K \vert α , N ) \approx αlog ( 1 + \frac{N}{α} ) ,$$

where E denotes the expected value, the symbol ≈ signifying “being approximated by”. According to the embodiments, the scale factor α may be considered as fixed or as a random variable whose value is estimated during each iteration of the inference.

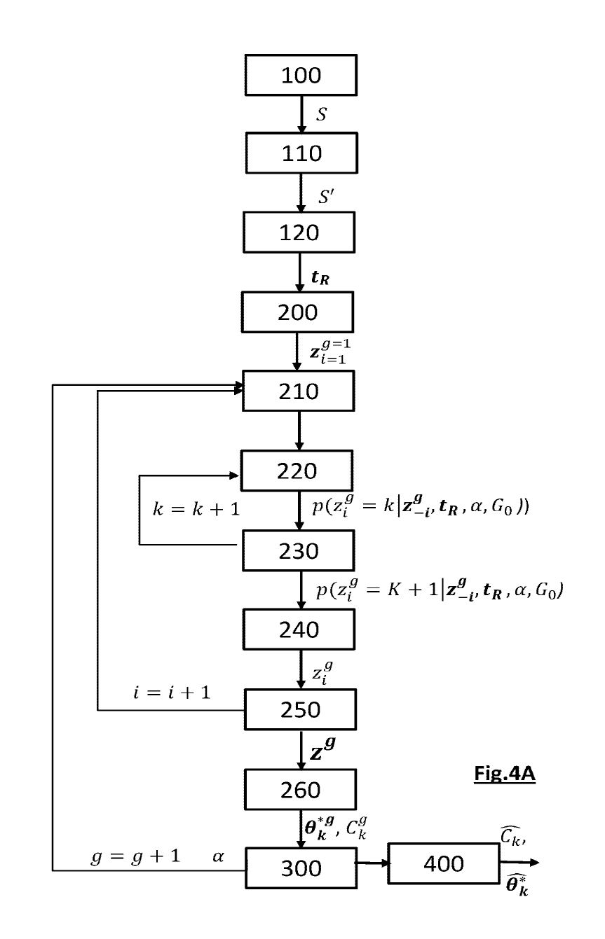

FIG. 3 is a representation of the statistical model, making apparent the hierarchical sequence of the model:
G₀ and α are the parameters of the DPMM previously described. In the example described, α follows a gamma probability law;
θ*ₖ is the vector of parameters of the distribution of the retention times associated with the class k, this vector being distributed according to the base distribution G₀: θ*ₖ˜G₀.
C is a vector of dimension (K,1), each term of which Cₖ represents, in this example, a proportion of molecules in the class k; C is distributed according to a Dirichlet distribution of parameters

$$( \frac{α}{K} … \frac{α}{K} ) .$$

In this example, Cₖε[0, 1] and ΣCₖ=1
z is a vector, of dimension (N,1), each term of which zᵢ represents the class of the retention time tᵢ of a molecule i. Each term zᵢ is distributed according to a multinomial law parameterized by the vector C in such a manner that zᵢ/C˜Multinomial (C₁ . . . C_{K}). The non-parametric Bayesian inference based on the DPMM aims to determine this vector z, referred to as state vector, during an iterative method. Each iteration g generates an update of this state vector denoted z^{g}.
t_{R} is a vector, of dimension (N, 1), each term of which is a retention time tᵢ of an individual molecule i. N denotes the number of retention times tᵢ being considered. Each retention time is distributed in such a manner that tᵢ|C˜Σₖ₌₁^{K} Cₖp(tᵢ|θ*ₖ).
S represents the chromatogram. If S* denotes the normalized chromatogram:

$${S}^{*} = \frac{s}{\int s} = p ( {t}_{i} \vert C , Θ ) = {Σ}_{k = 1}^{K} {C}_{k} p ( {t}_{i} \vert {θ}_{k}^{*} )$$

$$where Θ = [ {θ}_{1}^{*} … {θ}_{K}^{*} ] .$$

According to this embodiment, each probability density associated with a retention time tᵢ is a Gaussian, such that p(tᵢ|θ*ₖ)= [symbol] (tᵢ; μₖ, σ²ₖ), where μₖ and σ²ₖ respectively denote the mean and the variance of the retention time tᵢ of the molecules of the class k.

The base distribution G₀ of the parameters μₖ, σ²ₖ may be an inverse normal gamma distribution, such that (μₖ, σ²ₖ)˜G₀= [symbol] [symbol] [symbol] (m₀, [symbol] ₀, a₀, b₀,). The base distribution G₀ is then conjugated to the Gaussian distribution of the retention times.

If θᵢ represents the vector of parameters of the distribution of the retention times tᵢ, with θᵢ ε[θ*₁ . . . θ*_{K}], tᵢ|θᵢ˜p(tᵢ|θᵢ) with θᵢ|G˜G and G˜DP (G₀, α), DP denoting a Dirichlet process. The random process G is a discrete distribution, defined by G=Σₖ₌₁^{K} Cₖδ_{θ*}_{ₖ}, where δ_{θ*}_{ₖ} denotes the Dirac distribution in θ*ₖ. The distribution G defines a partitioning, corresponding to a definition of the parameters of each class, and also to the number of classes being considered. This partitioning may be unknown, the number of classes, together with their parameters, being a priori unknowns. It may also be partially known, in which case the number of classes K and/or certain parameters θ*ₖ of each class are known.

In the embodiment described, the partitioning is random and is updated during each iteration.

The main steps of the method will now be described in relation with FIG. 4A. These steps are grouped into 3 phases:
extraction of the observed data: steps 100 to 120;
inference according to a loop of the Collapsed Gibbs Sampling type: steps 200 to 300, after a first initialization iteration;
exit from the algorithm: step 400

Step 100: acquisition of the signal. This step corresponds to the acquisition of a chromatogram S.

Step 110: pre-processing of the chromatogram. This pre-processing comprises a normalization step, in order to obtain a normalized chromatogram S* such as previously defined, combined with a step for eliminating the base line, according to methods known to those skilled in the art, so as to obtain a histogram S′. This step is optional. Nevertheless, the elimination of the base line is preferable in order to improve the sensitivity of the method. It also allows the number of retention times belonging to a class representative of the noise to be reduced. The elimination of the base line may be carried out by extraction of the base line, for example by a moving average, then by the subtraction of the base line extracted from the raw signal.

Step 120: selection of the retention times. A random selection is made, according to the distribution formed by the chromatogram, potentially after normalization and/or elimination of the base line. A list of N retention times tᵢ is then constituted, forming a vector of the retention times t_{R}. This random selection may be obtained by a standard method using the inverse transform of the signal S′.

It should be noted that each retention time may have initially been subtracted from the dead time t₀ of the column, which corresponds to a retention time referred to as ‘adjusted’.

Step 200: Bayesian inference in order to assign a class to each retention time tᵢ of the vector t_{R}. The inference aims to establish the vector z, considered as a state vector, each term of which zᵢ represents the index of a class assigned to a retention time tᵢ.

This process is iterative, implemented according to a first iteration loop, each iteration allowing a classification vector z^{g} for each retention time to be established, the exponent g denoting the rank of the iteration. This state vector allows the quantities or proportions of molecules Cₖ^{g} to be established in each class k defined during the iteration g. It also allows a vector θ*ₖ^{g} to be established for the parameters of the distribution law for the retention times associated with each class k during the iteration g.

Prior to the first iteration, the process is initialized by considering there to be only a single class (K=1). During the first iteration (g=1), the classification is carried out according to a method of the CRP (Chinese Restaurant Process) type, known to those skilled in the art.

Step 210: For each molecule i, associated with a retention time tᵢ, a second iteration loop is launched, the iteration index being the index of the molecule i. A vector t_{R,-i} is then constituted, corresponding to the vector t_{R} of the retention times tᵢ constituted during the step 120, from which the retention time tᵢ is subtracted, this retention time tᵢ, so called current time, being associated with the index i considered during this step.

Step 220: an a posteriori probability is determined for the molecule i, via its retention time tᵢ, of belonging to each existing class k. For each class, this a posteriori probability is written:

p(zᵢ^{g}=k|z₋ᵢ^{g},t_{R},α,G₀)=p(zᵢ^{g}=k|z₋ᵢ^{g},α)p(tᵢ|t_{R,-i},zᵢ^{g}=k,z₋ᵢ^{g},G₀) (1)

where:
zᵢ^{g} is the class index assigned to the retention time tᵢ during the iteration g.
z₋ᵢ^{g} is the vector for assigning all of the iteration times (state vector) with the exception of the current time tᵢ during the iteration g.
   p(zᵢ^{g}=k|z₋ᵢ^{g}, α) is an a priori probability of belonging to an existing class k. During the first iteration, this probability is determined according to a Chinese Restaurant Process, known by those skilled in the art under the term or the acronym CRP.

When g=1 (1^{st} iteration) this probability may be written

$$p ( {z}_{i}^{g} = k \vert {z}_{- i}^{g} , α ) = \frac{{N}_{k}}{i - 1 + α} ; \qquad ( 2 )$$

when g>1 this probability may be written

$$p ( {z}_{i}^{g} = k \vert {z}_{- i}^{g} , α ) = \frac{{N}_{k}}{N - 1 + α} , \qquad ( {2}^{′} )$$

where Nₖ is the number of molecules assigned to the class k during the iteration g and N represents the number of retention times selected during the step 120.

During the first iteration g=1, for the first molecule i=1, K=1. The class number increases progressively as the other retention times in the list are considered.

p(tᵢ|t_{R,-i}, zᵢ^{g}=k, z₋ᵢ^{g}, G₀) represents an a posteriori probability of observing the retention time tᵢ. It may be written in the form of a ratio of likelihood functions according to the equality:

$$p ( {t}_{i} \vert {t}_{R , - i ,} {z}_{i}^{g} = k , {z}_{- i}^{g} , {G}_{0} ) = p ( {t}_{i} \vert {t}_{k , - i} , {G}_{0} ) = \frac{p ( {t}_{i ,} {t}_{k , - i} \vert {G}_{0} )}{p ( {t}_{k , - i} \vert {G}_{0} )} = \frac{p ( {t}_{k} \vert {G}_{0} )}{p ( {t}_{k , - i} \vert {G}_{0} )} \qquad ( 3 )$$

where tₖ and t_{k,-i} are vectors comprising the retention time assigned to the class k respectively obtained by considering and without considering the current retention time tᵢ.

Given that the base distribution G₀ follows an inverse gamma law [symbol] [symbol] [symbol] (m₀, [symbol] ₀, a₀, b₀), it may be shown that

$$p ( {t}_{k , - i} \vert {G}_{0} ) = 𝒯 ( {m}_{k} , \frac{{b}_{k} ( {𝒦}_{k} + 1 )}{{𝒦}_{k} {a}_{k}} , 2 {a}_{k} ) \qquad ( {3}^{′} )$$

with:

$${m}_{k} = \frac{{m}_{0} {𝒦}_{0} + {N}_{k} {μ}_{k}}{{𝒦}_{0} + {N}_{k}} , \\ {𝒦}_{k} = {𝒦}_{0} + {N}_{k} , \\ {a}_{k} = {a}_{0} + \frac{{N}_{k}}{2} , \\ {b}_{k} = {b}_{0} + \frac{1}{2} {\sum }_{j = 1}^{{N}_{k}} {( {t}_{j} - {μ}_{k} )}^{2} + \frac{{N}_{k} {{𝒦}_{0} ( {μ}_{k} - {m}_{0} )}^{2}}{2 ( {𝒦}_{0} + {N}_{k} )}$$

where μₖ denotes the average of the retention times of the class k, the term Σⱼ₌₁^{N}^{ₖ}(tⱼ−μₖ)² being determined for each retention time tⱼ of the class k.

The notation

$$𝒯 ( {m}_{k} , \frac{{b}_{k} ( {𝒦}_{k} + 1 )}{{𝒦}_{k} {a}_{k}} , 2 {a}_{k} )$$

corresponds to a Student law with a mean mₖ, a scale parameter

$$\frac{{b}_{k} ( {𝒦}_{k} + 1 )}{{𝒦}_{k} {a}_{k}}$$

with 2aₖ degrees of freedom.

Thus, in relation with FIG. 4B, the step 220 comprises:
a sub-step 221 for calculating p(zᵢ^{g}=k|z₋ᵢ^{g}, α) according to (2) or (2′);
a sub-step 222 for calculating p(tᵢ|t_{R,-i}, zᵢ^{g}=k, z₋ᵢ^{g}, G₀) according to (3);
a sub-step 223 for calculating p(zᵢ^{g}=k|z₋ᵢ^{g}, t_{R}, α, G₀) according to (1), starting from (2) or (2′) and (3).

The step 220 is repeated, for the same molecule (i), for the K classes, which constitutes a third iteration loop.

Step 230: Determination of an a posteriori probability of belonging to a new class K+1, such that

p(zᵢ^{g}=K+1|z₋ᵢ^{g},t_{R},α,G₀)=p(zᵢ^{g}=K+1|z₋ᵢ^{g},α)p(zᵢ^{g}=K+1|z₋ᵢ^{g},α,t_{R},G₀) (4).

In an analogous manner to the step 220, the step 230 comprises, in relation with FIG. 4C:
a sub-step 231 for calculating an a priori probability of belonging to the new class K+1 p(zᵢ^{g}=K+1/z₋ᵢ^{g}, α), such that,

$$\begin{matrix}when g = 1 , p ( {z}_{i}^{g} = K + 1 \vert {z}_{- i}^{g} , α ) = \frac{α}{i - 1 + α} & ( 5 ) \\ when g > 1 , p ( {z}_{i}^{g} = K + 1 \vert {z}_{- i}^{g} , α ) = \frac{α}{N - 1 + α} & ( {5}^{′} )\end{matrix}$$

a sub-step 232 for calculating an a posteriori probability p(tᵢ|t_{R,-i}, zᵢ^{g}=K+1, z₋ᵢ^{g}, G₀)=p(tᵢ|t_{k,-i}, G₀), by considering that

$$p ( {t}_{i} \vert {t}_{k , - i} , {G}_{0} ) = 𝒯 ( {m}_{0} , \frac{{b}_{0} ( {𝒦}_{0} + 1 )}{{𝒦}_{0} {a}_{0}} , 2 {a}_{0} ) \qquad ( 6 )$$

a sub-step 233 for calculating p(zᵢ^{g}=K+1|z₋ᵢ^{g}, t_{R} α, G₀) according to (4).

Step 240 Classification of the current time tᵢ.

This step aims to assign a class k to the current time tᵢ, in other words to define the term zᵢ^{g} of the vector z^{g} as a function of the a posteriori probabilities of the molecule i belonging to each existing class k (i−e p(zᵢ^{g}=k|z₋ᵢ^{g}, t_{R}, α, G₀)) or to a new class K+1 (i−e p(zᵢ^{g}=K+1|z₋ᵢ^{g}, t_{R}, α, G₀)) respectively estimated during the steps 220 and 230. zᵢ^{g} is obtained by sampling according to the multinomial distribution of parameters of the K+1 probabilities p(zᵢ^{g}=k|z₋ᵢ^{g}, α, t_{R}, G₀) after normalization of the latter, in such a manner that, after the normalization, Σₖ₌₁^{K+1}p(zᵢ^{g}=k|z₋ᵢ^{g}, α, t_{R}, G₀)=1

Step 250 Adjustment of the number of classes. Here, account is taken of the value of zᵢ^{g} determined during the preceding step for updating the number K of classes.

During this adjustment step, beyond the first iteration, in other words for g>1, any empty class is eliminated. ‘Empty class’ is understood to mean a class not comprising any retention times. This corresponds, for example, to the case where the current retention time tᵢ, the only member of a class, is assigned to another class.

The steps 210 to 250 are iterated (second iteration loop) for each retention time tᵢ forming the vector t_{R}.

Step 260: Exit from the second iteration. Knowing the state vector z^{g}, the quantities or the proportions Cₖ^{g} of the classes of the molecules associated with the iteration g may be established, together with the parameters θ*ₖ^{g} of the distribution law for the retention times associated with each class defined during an iteration g.

Step 300 Selection of the scale factor.

In this example, the scale factor α follows a gamma law Γ(a, b), a and b being strictly positive real numbers. A random variable η is then introduced, such that η˜Beta(α+1, N) and:

$$α \vert η , K \sim {π}_{η} Γ ( a + K , b - log ( η ) ) + ( 1 - {π}_{η} ) Γ ( a + K - 1 , b - log ( η ) ) \\ where \frac{{π}_{η}}{1 - {π}_{η}} = \frac{( a + K - 1 )}{( N ( b - log ( η ) ) )} \qquad ( 7 )$$

During each iteration of g (first iteration), a sampling of a according to (7) is carried out.

The steps 210 à 300 are iterated (first iteration loop), in such a manner that each iteration of rank g establishes a state vector z^{g}. Thus, during each iteration, the partitioning of the retention times on the list is updated, in other words the number of classes and their parameters, together with the classification of these retention times, in other words the assignment of each retention time to a class, which corresponds to an update of the state vector z^{g}.

The first iteration loop ceases when an endpoint criterion is reached. This endpoint criterion may be a predetermined number of iterations or the attainment of a convergence criterion. Such a convergence criterion may be a measurement of the variation of the a posteriori law of the state vector during the iterations, the iteration being halted when the variation of the a posteriori law of the state vector z^{g} is considered as stable.

Step 400: Exit from the algorithm. Knowing the state vector z^{g}, the quantities or proportions [symbol] of the classes of the molecules can be estimated, together with the parameters [symbol] of the distribution law for the retention times associated with each class:

[symbol]

=Cₖ^{g}^{_{f}}

[symbol]

=θ*ₖ^{g}

where the index g_{f} denotes the last iteration.

According to one variant, this estimation is not carried out on the basis of the last iteration g_{f}, but on the basis of a plurality of iteration, in particular considering the indices g varying between an index g_{d} corresponding to the end of a time referred to as warm-up time, and the index g_{f} denoting the last iteration. The warm-up time corresponds to the time when the classification process has stabilized.

This estimation may be carried out by calculating a mean value:

$$\hat{{C}_{k}} = \frac{1}{{g}_{f} - {g}_{d} + 1} {\sum }_{{g}_{d}}^{{g}_{f}} {C}_{k}^{g}$$

$$\hat{{θ}_{k}^{*}} = \frac{1}{{g}_{f} - {g}_{d} + 1} {\sum }_{{g}_{d}}^{{g}_{f}} {θ}_{k}^{* g}$$

Another option is to select the a posteriori maximum of the random variables Cₖ, θ*ₖ^{g} from the g_{f}−g_{d}+1 values Cₖ^{g}, respectively θ*ₖ^{g}, for g in the range between g_{d} and g_{f}.

Knowing the concentrations within each class, the concentrations of the molecules of each class in the sample may be deduced from these, by considering that the number of retention times constituting the list is sufficiently high to be representative of the sample. Each class is representative of one species of molecules.

The method can also allow the quantities of molecules in the sample to be established from the quantities of molecules within each class, with the additional application of a correction factor that may be determined by calibration.

According to one variant, the step 400 also comprises a sub-step for selecting classes of interest, or target classes, from amongst the classes identified by the algorithm. For this purpose, a comparison is made of parameters [symbol] from the classes previously estimated with one or more known parameters θₗ from one or more classes, each class corresponding to a target molecule l. The term ‘target molecule’ denotes a molecule whose proportion or concentration in the mixture it is desired to determine. A distribution of the retention times, one or more parameters θₗ of which is/are known, is associated with each target molecule l. These parameters may for example be established based on the moments of the said distribution. The parameters [symbol] of the classes obtained during the step 400 are then compared with the parameters θₗ of each target molecule, in such a manner as to identify the class k potentially corresponding to a target molecule. A quantity of each target molecule thus identified is then determined, and it is then possible to carry out a new normalization of the quantity relative to the whole of the classes corresponding to a target molecule l, so as to establish a proportion of the target molecules in the mixture

The parameters θₗ of the distribution of the retention times for each target molecule are first of all determined, either by learning, or by modelling, or by experimental tests. These parameters are for example a mean, moments, or other statistical parameters.

### Experimental Tests

The method described hereinabove has been applied to a chromatogram obtained experimentally. The operating conditions are the following:
capillary column with a length of 30 metres, a diameter of 0.25 mm, whose stationary phase, with a thickness of 0.25 μm, has the following composition: 5% phenyl-arylene, 95% dimethyl-polysiloxane. A temperature gradient of 5° C./min has been applied from 50° C. to 300° C. The volume injected is 0.5 μL, at a pressure of 12 psi, corresponding to a flow rate of 1 mL/min. exit detector: Flame Ionisation Detector.
sample analysed: solution of methanol comprising 5 polycyclic aromatic hydrocarbons (HAP): Acenaphthene (ACE), Anthracene (ANT), Fluoranthene (FTN), Benzo(a)pyrene (B(A)P) and Indeno(1,2,3-cd)pyrene (IND). The concentration of each of these compounds in the solution is around 100 μg/mL. This sample furthermore comprised an unwanted contaminant, referenced C1.

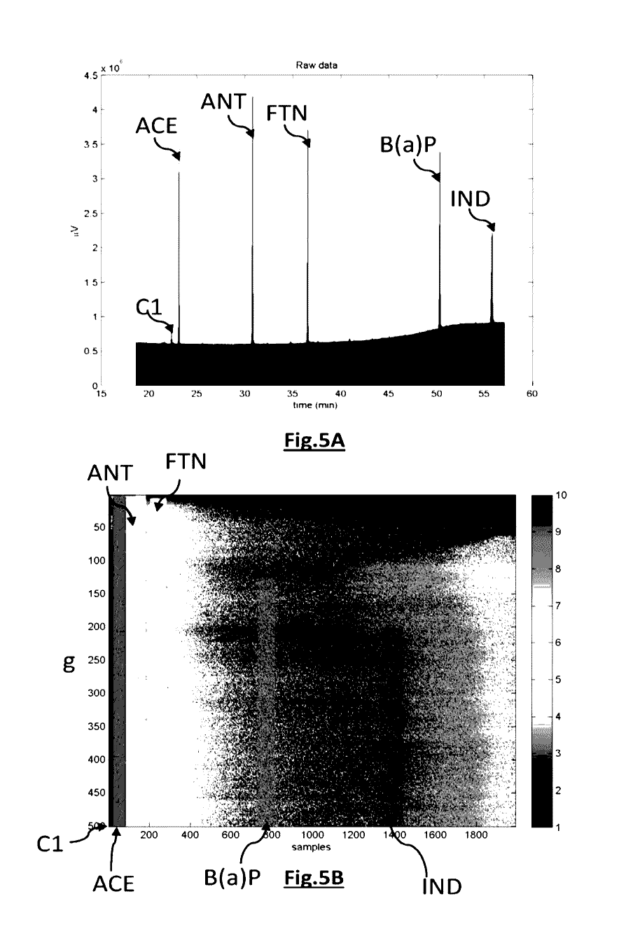

FIG. 5A shows the measured raw histogram. The base line has not been subtracted. N retention times (N=2000) have been randomly selected according to this histogram. The 5 HAPs are clearly apparent in the form of peaks, as is the unwanted contaminant.

FIG. 5B shows, in the form of a colour code, the class assigned to each retention time tᵢ, in other words to each molecule, as a function of the number of iterations g. It is observed that:
the number of classes increases up to the iteration g≈200. The period corresponding to 1≦g≦200 corresponds to a period referred to as ‘warm-up period’, during which the number of classes varies from one iteration to another.
When g>200, the number of classes is stabilized at 10. The assignment of the classes, is as follows:
Class 1: first base line segment;
Class 2: Contaminant C1;
Class 3: ANT;
Class 4: ACE;
Class 5: FTN;
Class 6: second base line segment;
Class 7: fourth base line segment;
Class 8: third base line segment
Class 9: B(a)P
Class 10: IND

The 5 HAPs are indeed included. The other classes partitioning the histogram correspond to the unexpected contaminant, together with 4 segments of the base line, equivalent to the noise, extending between the peaks of the HAPs.

Aside from a classification of the molecules forming the sample, the method also allows the detection of contaminants, together with the discrimination of segments of the base line.

The algorithm also allows the parameters θ*ₖ of the distributions associated with each class, in other words with each species of molecule, to be determined.

Although described in relation with the analysis of gaseous molecules, the invention can be implemented in a liquid medium, or for the analysis of biological particles, for example proteins or peptides.

1. A Method for estimating a quantity of particles present in a sample, comprising:
a) passing the sample through a chromatography column, the said column comprising a detector capable of detecting the said particles, the detector delivering a chromatogram representing the number of particles detected as a function of a retention time, representative of the time spent by each particle in the column;
b) constituting a list comprising a plurality of retention times, each retention time being associated with an individual particle, the said list being established by random sampling from the said chromatogram;
c) carrying out a classification of each retention time on the said list according to a plurality of classes, with each class there being associated an a priori distribution of the retention times defined by parameters, the said parameters being distributed according to a predetermined base distribution;
d) estimating a quantity or a proportion of particles whose retention time is classified according to at least one of the said classes defined during the step c).

2. The method according to claim 1, in which the steps c) to d) are carried out in an iterative, manner until an endpoint criterion is reached.

3. The method according to claim 2 in which the step c) comprises setting up a state vector, each term of which represents an assigned class for a retention time, the said state vector being updated at each iteration.

4. The method according to claim 2, in which the number of classes is updated at each iteration.

5. The method according to claim 4, according to which, at each iteration, the step c) comprises a step for searching for an empty class, not comprising any retention time, such a class then being eliminated.

6. The method according to claim 1, in which the step c) is carried out by Bayesian inference.

7. The method according to claim 6, in which the step c) is carried out by non-parametric Bayesian inference.

8. The method according to claim 1, in which, during the step c), the said plurality of retention times is modelled according to a Dirichlet process mixture model, the said model being parameterized by the said base distribution and by a scale factor.

9. The Method according to claim 8, in which, the scale factor being distributed according to a parametric law, its value is inferred at each iteration by sampling according to the said parametric law.

10. The Method according to claim 2, according to which, at each iteration, the step c) comprises the determination, for each retention time, of an a posteriori probability of belonging to each class previously defined, the classification being carried out by a selection according to a multinomial law whose parameters comprise the said a posteriori probabilities.

11. The Method according to claim 10, in which the determination of the a posteriori probability of belonging to each class previously defined comprises the determination:
of a priori probability laws for the said particle of belonging to each class previously defined, knowing the respective classes of the other particles;
of a posteriori probability laws for observation of the retention time of the said particle knowing the retention times of the other particles, together with their respective classes, each probability being successively calculated by considering that the said particle belongs to each class.

12. The Method according to claim 10, in which the step c) also comprises determining, for each retention time, of an a posteriori probability of belonging to a class that is additional with respect to the classes previously defined.

13. The Method according to claim 12, in which the determination of the said a posteriori probability of belonging to an additional class comprises determining:
of a priori probability law for the said particle of belonging to an additional class with respect to the classes previously defined, knowing the respective classes of the other particles;
of a posteriori probability law of observing the retention time of the said particle knowing the retention time of the other particles, together with their respective classes, this probability being calculated by considering that the said particle belongs to the said additional class.

14. The Method according to claim 1, in which the class number is fixed at a value previously established.

15. The Method according to claim 1, comprising:
e) estimating a quantity or a proportion of particles in the sample based on the quantities or proportions estimated during the step d).

16. The Method according to claim 15, in which the step e) also comprises the estimation of the parameters of at least one class using the parameters estimated during the step d).

17. The Method according to claim 14, comprising:
f) identifying at least one target class, corresponding to a particle determined a priori, referred to as target particle, with each target particle there being associated a distribution of retention times whose parameters are known, the identification being carried out by means of a comparison between at least one parameter associated with each class and at least the said parameter associated with the said target particle.

18. An Information recording medium, readable by a processor, comprising instructions for the execution of a method according to claim 1, these instructions being designed to be executed by the processor.

19. A Device for analysing a liquid or gaseous sample, comprising a plurality of particles, the device comprising:
a chromatography column, extending between an entry and an exit, designed to be traversed by the sample, the column comprising a wall comprising a stationary phase able to adsorb and to desorb the said particles;
a detector, disposed at the exit of the column, designed to generate a signal representative of a quantity of particles having passed through the said column as a function of time;
a processor, configured to process the signal generated by the detector, the processor being configured for implementing the Method of claim 1.
